(19) United States
(12) Patent Application Publication
(10) Pub. No.: US 2011/0171278 A1
(43) Pub. Date: Jul. 14, 2011

(54) ANIMAL OLFACTORY REPELLANT COMPOSITION CONTAINING MUSTARD OIL AND EUCALYPTUS OIL

(76) Inventor: RONALD H. DEIBERT, CALGARY (CA)

(21) Appl. No.: 12/686,644

(22) Filed: Jan. 13, 2010

(51) Int. Cl. A01N 25/08; A01P 17/00; A01N 43/16

(52) U.S. Cl. 424/409; 514/456

(57) ABSTRACT

Olfactory animal repellant compositions containing volatile oil of mustard and essential oil of eucalyptus, and methods for using the same are provided.

### FIELD OF THE INVENTION

The present invention relates generally to novel animal repellant compositions and methods for using the same for repelling animals.

### BACKGROUND OF THE INVENTION

It is desirable to discourage animals from areas that are either hazardous to the animal's health and/or to human health. Chemical agents are often employed to discourage animals from such areas. There are many available chemical compounds which would effectively repel animals; however, toxicity and odor limit the use of these chemical compounds. It has become increasingly apparent that the widespread use of synthetic pesticides and repellants had caused detrimental environmental effects that are harmful to humans and other animals. The public is concerned about the amount of residual chemicals that persist in food, ground water and the environment, and that are toxic, carcinogenic or otherwise incompatible to humans, domestic and non-domestic animals and/or fish.

Therefore, suitable repellant compositions must be substantially, and preferably completely, non-toxic to mammals and the environment, and must not have an odor that is repulsive or unpleasant to humans, as it would not be usable in proximity to human presence. Botanical compositions are of great interest because they are natural repellants, i.e. toxicants derived from plants that are safe to humans and the environment. Plant essential oils have been tired. However, plant essential oils when used alone can be expensive, impractical, or ineffective under certain circumstances.

Accordingly, there is a need for a novel animal repellant composition that is non-toxic to humans, plants and animals, is environmentally friendly, does not release an unpleasant odor to humans, and includes plant essential oils.

### SUMMARY OF THE INVENTION

An object of the present invention is to provide novel animal olfactory repellant compositions for use in discouraging animals from entering undesired areas.

Another object of the present invention is to provide novel animal olfactory repellant compositions containing mustard oil and eucalyptus oil in wildlife applications.

Another object of the present invention is to provide novel animal olfactory repellant compositions containing mustard oil and eucalyptus oil in household applications.

Another object of the present invention is to provide novel animal olfactory repellant compositions containing mustard oil and eucalyptus oil in lawn and garden applications.

Another object of the present invention is to provide novel animal olfactory repellant compositions containing mustard oil and eucalyptus oil suitable for liquid application by means of a spray applicator of the pump type, or an aerosol-type applicator.

Another object of the present invention is to provide novel animal olfactory repellant compositions containing mustard oil and eucalyptus oil suitable for solid application by means of hand spreading or by mechanical spreading of the broadcast spreader type.

Another object of the present invention is to is to provide novel animal olfactory repellant compositions containing mustard oil and eucalyptus oil in a gelatin carrier for slow release applications.

Another object of the present invention is to provide novel animal olfactory repellant compositions containing mustard oil, eucalyptus oil and mineral oil.

It is also an object of the present invention to provide a safe animal olfactory repellant composition and method that will not harm mammals or the environment.

It is also an object of the present invention to provide an animal olfactory repellant composition that has a scent that is not unpleasant to humans.

It is further an object of the present invention to provide an animal olfactory repellant composition that can be applied without burdensome safety precautions.

It is still another object of the present invention to provide an animal olfactory repellant composition that is inexpensively produced or employed.

It is still another object of the present invention to provide an animal olfactory repellant composition that can be safely applied to plants.

One or more of the above non-limiting objects and technical effects are accomplished by the present invention, which is directed to animal olfactory repellant compositions comprising mustard oil and eucalyptus oil. The animal olfactory repellant compositions of the present invention can be applied and used as liquid sprays, gels, pellets, impregnating material.

As used herein, the term “mustard oil” (volatile oil of mustard) denotes both extracted (by distillation of the seeds of black mustard (Brassica nigra) or brown Indian mustard (Brassica juncea)) and synthetic versions thereof having at least Allyl isothiocyanate.

As used herein, the term “Eucalyptus oil” (essential oil of eucalyptus) denotes both extracted and synthetic versions of Eucalyptus cneorifolia, Eucalyptus dives, Eucalyptus dumosa, Eucalyptus globulus, Eucalyptus goniocalyx, Eucalyptus horistes, Eucalyptus kochii, Eucalyptus leucoxylon, Eucalyptus oleosa, Eucalyptus polybractea, Eucalyptus radiate, Eucalyptus sideroxylon, Eucalyptus smithii, Eucalyptus tereticornis, Eucalyptus viridis and derivatives thereof.

As used herein, the term “mineral oil” denotes petroleum based mineral oil; paraffinic oils, based on n-alkanes; naphthenic oils, based on cycloalkanes; aromatic oils, based on aromatic hydrocarbons; dormant oil; cottonseed oil; unrefined cottonseed oil; superior oil; horticultural oil; white mineral oil; Paraffin oil; liquid petrolatum; White Mineral Oil; Nujol and derivatives thereof.

The animal repellant compositions of the present invention may be used in repelling or controlling the presence of domestic and non-domestic animals including but not limited to bear, elk, deer, rodents, rabbit, gopher, cats, and dogs.

In one aspect, the present invention relates to animal repellant compositions containing mustard oil and eucalyptus oil against animals from entering areas where food for human consumption is grown, processed or stored.

In another aspect, the present invention relates to animal repellant compositions containing mustard oil and eucalyptus oil against animals from entering areas which would present a threat to human safety.

In still another aspect, the present invention relates to animal repellant compositions containing mustard oil and eucalyptus oil against animals from entering areas which would present a threat to the animal's safety, for example along railways and roadways.

The present invention also relates to animal repellant compositions comprising mustard oil and eucalyptus oil in combination with a carrier or with diluents such as mineral oil (e.g. petroleum based mineral oil; paraffinic oils, based on n-alkanes; naphthenic oils, based on cycloalkanes; aromatic oils, based on aromatic hydrocarbons; dormant oil; cottonseed oil; unrefined cottonseed oil; superior oil; horticultural oil; white mineral oil; Paraffin oil; liquid petrolatum; White Mineral Oil; Nujol and derivatives thereof).

The present invention also relates to animal repellant compositions comprising an olfactory repellant, a cytokine inhibitor, and a carrier. The cytokine inhibitor can be a cineole-based oil. The cineole-based oil can be extracted or synthetic essential oil of eucalyptus of Eucalyptus cneorifolia; Eucalyptus dives; Eucalyptus dumosa; Eucalyptus globulus; Eucalyptus goniocalyx; Eucalyptus horistes; Eucalyptus kochii; Eucalyptus leucoxylon; Eucalyptus oleosa; Eucalyptus polybractea; Eucalyptus radiate; Eucalyptus sideroxylon; Eucalyptus smithii; Eucalyptus tereticornis; Eucalyptus viridis and derivatives thereof.

The present invention further relates to various optimum ratios between and among the constituents of each proprietary blend and the proper delivery system for each blend. For instance, the mixing ratio of an olfactory repellant to a cytokine inhibitor is the ratio wherein the olfactory repellant and cytokine inhibitor show a synergistic effect.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### DETAILED DESCRIPTION OF THE INVENTION

The inventor has found animal repellant compositions including Allyl isothiocyanate (mustard oil) and cineole-based oil (essential oil of eucalyptus) have a broad range of applicability in repelling mammalian animals. Compositions according to the present invention comprise additional natural or essential oils as additional components, and are therefore particularly advantageous in terms of their relative non-toxicity.

The present invention provides efficacious animal repellant compositions that may be designated as biorepellants in that they comprise a chemical substance of natural origin that can be synthesized. The animal repellant compositions of the present invention have active ingredients that have been proven to be substantially non-toxic to humans and domestic animals and which have minimal adverse effects on wildlife and the environment.

In one embodiment, an animal repellant composition comprises mustard oil and essential oil of eucalyptus in an admixture with mineral oil. In this embodiment, mustard oil is present in an amount of about 0.05-5.0% by total volume, essential oil of eucalyptus is present in an amount of about 0.05-5.0% by total volume, and mineral oil is present in an amount of about 90-99% by total volume.

In another embodiment, an animal repellant composition comprises mustard oil and essential oil of eucalyptus in an admixture with dormant mineral oil and water. In this embodiment, mustard oil is present in an amount of about 0.5-5.0% by total volume, essential oil of eucalyptus is present in an amount of about 0.5-5.0% by total volume, mineral oil is present in an amount of about 90-99% by total volume. This animal repellant mixture is then mixed with water at up to a 20 parts water to 1 part animal repellant mixture.

In another embodiment, an animal repellant composition comprises a liquid portion including mustard oil and essential oil of eucalyptus in an admixture with mineral oil, and a solid portion including zeolite. In this embodiment, mustard oil is present in an amount of about 0.5-5.0% by total volume, essential oil of eucalyptus is present in an amount of about 0.5-5% by total volume, and mineral oil is present in an amount of about 90-99% by total volume. The liquid portion is added to the zeolite to be absorbed thereby in amount that doesn't completely saturate the zeolite. This embodiment, is useful for spreading the animal repellant composition on the ground in small or large areas by hand or by broadcast spreading using a mechanical granular spreading device. The addition of the zeolite prevents the ground or soil from coming in direct contact with the liquid portion and neutralizing the active ingredients. Further, zeolite acts as a water moderator, in which it will adsorb up to 55% of its weight in water and slowly release it under demand.

Preferably natural zeolite is used and derived from Amicite; Analcime; Barrerite; Bellbergite; Bikitaite; Boggsite; Brewsterite; Chabazite; Clinoptilolite; Cowlesite; Dachiardite; Edingtonite; Epistilbite; Erionite; Faujasite; Ferrierite; Garronite; Gismondine; Gmelinite; Gobbinsite; Gonnardite; Goosecreekite; Harmotome; Herschelite; Heulandite; Laumontite; Levyne; Maricopaite; Mazzite; Merlinoite; Mesolite; Montesommaite; Mordenite; Natrolite; Offretite; Paranatrolite; Paulingite; Pentasil; Perlialite; Phillipsite; Pollucite; Scolecite; Sodalite; Sodium Dachiardite; Stellerite; Stilbite; Tetranatrolite; Thomsonite; Tschernichite; Wairakite; Wellsite; Willhendersonite; Yugawaralite; and mixtures thereof.

The term “carrier” as used herein means an inert or fluid material, which may be inorganic or organic and of synthetic or natural origin, with which the active compound is mixed or formulated to facilitate its application, or its storage, transport and/or handling. The animal repellant compositions of the instant invention also typically comprise an inert carrier, in an amount in which the inert carrier can assist the instant active ingredient to be carried through a process or method of controlling pests. As such an amount of the inert carrier, the inventive animal repellant compositions preferably comprise the inert carrier in an amount of from about 5-99.9%, provided that such a carrier is a solid, liquid or gas carrier, or a combination thereof. In such a case, examples of the solid carriers that may be in the animal repellant compositions of the instant invention include clays such as kaolin, diatomaceous earth, bentonite, fubasami clay and terra alba, synthetic hydrated silicon oxides, talc, ceramics, other inorganic minerals which are useful in producing formulated compositions such as sericite, quartz, sulfur, active carbons and calcium carbonate, chemical fertilizers such as ammonium sulfate, ammonium phosphate, ammonium nitrate, urea and ammonium chloride, and the like, as well as powders thereof, granules thereof, and a mixture thereof; examples of the liquid carriers that may be in the animal repellant compositions of the instant invention include water, alcohols such as methanol and ethanol, aromatic hydrocarbons such as toluene, xylene, ethylbenzene and alkyl naphthalenes, non-aromatic hydrocarbons such as hexane, cyclohexane, kerosene, isoparoffinic and normal paroffinic solvents and light oils, esters such as ethyl acetate and butyl acetate, nitrites such as acetonitrile and isobutylonitrile, ethers such as diisopropyl ether and dioxane, amides such as N,N-dimethylformamide and N,N-dimethylacetamide, halogenated hydrocarbons such as dichloromethane, trichloroethane and carbon tetrachloride, dimethylsulfoxide, botanical oils such as soy oil and cotton seed oil, and the like, and a mixture thereof and examples of the gas carriers that may be in the aerosol form of animal repellant compositions of the instant invention include propellants such as butane gas, propane gas, liquid petroleum gas, dimethyl ether, carbon dioxide, nitrogen, and the like, and a mixture thereof.

The inventive animal repellant compositions of the present invention may be employed alone or in the form of mixtures with such solid and/or liquid dispersible carrier vehicles and/or other known compatible active agents such as insecticides, acaricides, nematicides, fungicides, bactericides, rodenticides, herbicides, fertilizers, growth-regulating agents, etc., if desired, or in the form of particular dosage preparations for specific application made therefrom, such as solutions, emulsions, suspensions, powders, pastes, and granules which are thus ready for use. The animal repellant compositions of the present invention can be formulated or mixed with, if desired, conventional inert pesticide diluents or extenders of the type usable in conventional pesticide formulations or compositions, e.g. conventional pesticide dispersible carrier vehicles such as gases, solutions, emulsions, suspensions, emulsifiable concentrates, spray powders, pastes, soluble powders, dusting agents, granules, foams, pastes, tablets, aerosols, natural and synthetic materials impregnated with active compounds, microcapsules, coating compositions for use on seeds, and formulations used with burning equipment, such as fumigating cartridges, fumigating cans and fumigating coils, as well as ULV cold mist and warm mist formulations, etc. In addition, mineral oil and the essential oils disclosed herein (e.g., safflower oil, benzyl alcohol, citronellal, d-limonene, soybean oil, sesame oil, etc.) may also serve as diluents or carriers in the animal repellant compositions of the present invention.

Formulations containing the animal repellant compositions of the present invention may be prepared in any known manner, for instance by extending the animal repellant compositions with conventional liquid carriers and/or dispersible solid carriers optionally with the use of carrier vehicle assistants, e.g. conventional surface-active agents, including emulsifying agents and/or dispersing agents, whereby, for example, in the case where water is used as diluent, organic solvents may be added as auxiliary solvents. Suitable liquid diluents or carriers include water, petroleum distillates, or other liquid carriers with or without surface active agents. The choice of dispersing and emulsifying agents and the amount employed is dictated by the nature of the composition and the ability of the agent to facilitate the dispersion of the animal repellant compositions of the present invention. Non-ionic, anionic, amphoteric, or cationic dispersing and emulsifying agents may be employed, for example, the condensation products of alkylene oxides with phenol and organic acids, alkyl aryl sulfonates, complex ether alcohols, quarternary ammonium compounds, and the like.

Liquid concentrates may be prepared by dissolving a composition of the present invention with a solvent and dispersing the animal repellant compositions of the present inventions in water with suitable surface active emulsifying and dispersing agents. Examples of conventional carrier vehicles for this purpose include, but are not limited to, aerosol organic solvents, such as aromatic hydrocarbons (e.g. benzene, toluene, xylene, alkyl naphthalenes, etc.), halogenated especially chlorinated, aromatic hydrocarbons (e.g. chlorobenzenes, etc.), cycloalkanes, (e.g. cyclohexane, etc.). paraffins (e.g. petroleum or mineral oil fractions), chlorinated aliphatic hydrocarbons (e.g. methylene chloride, chloroethylenes, etc.), alcohols (e.g. methanol, ethanol, propanol, butanol, glycol, etc.) as well as ethers and esters thereof (e.g. glycol monomethyl ether, etc.), amines (e.g. ethanolamine, etc.), amides (e.g. dimethyl formamide etc.) sulfoxides (e.g. dimethyl sulfoxide, etc.), acetonitrile, ketones (e.g. acetone, methyl ethyl ketone, methyl isobutyl ketone, cyclohexanone, etc.), and water.

Surface-active agents, i.e., conventional carrier vehicle assistants, that may be employed with the present invention include, without limitation, emulsifying agents, such as non-ionic and/or anionic emulsifying agents (e.g. polyethylene oxide esters of fatty acids, polyethylene oxide ethers of fatty alcohols, alkyl sulfates, alkyl sulfonates, aryl sulfonates, albumin hydrolyzates, etc. and especially alkyl arylpolyglycol ethers. In the preparation of wettable powders, dust or granulated formulations, the active ingredient is dispersed in and on an appropriately divided carrier. In the formulation of the wettable powders the aforementioned dispersing agents as well as lignosulfonates can be included. Dusts are admixtures of the compositions with finely divided solids such as talc, attapulgite clay, kieselguhr, pyrophyllite, chalk, diatomaceous earth, vermiculite, calcium phosphates, calcium and magnesium carbonates, sulfur, flours, and other organic and inorganic solids which act as carriers for the animal repellant.

Further, the animal repellant compositions of the instant invention may additionally contain a coloring agent, a formulation auxiliary, or a combination thereof. As such, examples of such coloring agents that may be utilized in the animal repellant compositions of the instant invention include inorganic pigments such as metal oxides, titanium oxides and Prussian blue, organic dyes such as alizarine dyes, azo dyes and metallic phthalocyanine dyes, iron, manganese, boron, copper, cobalt, molybdenum, zinc and salts thereof, and the like, or a mixture thereof; and examples of such formulation auxiliaries that may be utilized in the animal repellant compositions of the instant invention include attaching and/or dispersing agents, surfactants, stabilizers, and the like, or a mixture thereof.

If desired, colorants such as inorganic pigments, for example, iron oxide, titanium oxide and Prussian Blue, and organic dyestuffs, such as alizarin dyestuffs, azo dyestuffs or metal phthalocyanine dyestuffs, and trace elements, such as salts of iron, manganese, boron, copper, cobalt, molybdenum and zinc may be used.

In commercial applications, the present invention encompasses carrier composition mixtures in which the animal repellant compositions are present in an amount substantially between about 0.01-100% by weight, and preferably 0.5-90% by weight, of the mixture, whereas carrier composition mixtures suitable for direct application or field application generally contemplate those in which the active compound is present in an amount substantially between about 0.0001-10%, preferably 0.01-2%, by weight of the mixture. Thus, the present invention contemplates over-all formulations that comprise mixtures of a conventional dispersible carrier vehicle such as (1) a dispersible inert finely divided carrier solid, and/or (2) a dispersible carrier liquid such as an inert organic solvent and/or water, preferably including a surface-active effective amount of a carrier vehicle assistant, e.g. a surface-active agent, such as an emulsifying agent and/or a dispersing agent, and an amount of the active compound which is effective for the purpose in question and which is generally between about 0.0001-100%, and preferably 0.01-95%, by weight of the mixture.

A number of embodiments of the present invention have been described. Nevertheless, it will be understood that various modifications may be made without departing from the spirit and scope of the invention. Accordingly, other embodiments are within the scope of the following claims.

What is claimed is:

1. An animal repellant composition, comprising:
an olfactory repellant;
a cytokine inhibitor; and
a carrier.

2. The animal repellant composition of claim 1 comprising from about 0.5-5.0% by volume of said olfactory repellant, from about 0.5-5.0% by volume of said cytokine inhibitor, and from about 90-99% by volume of said carrier.

3. The animal repellant composition of claim 2, wherein said olfactory repellant is Allyl isothiocyanate, said cytokine inhibitor is cineole-based oil, and said carrier is mineral oil.

4. The animal repellant composition of claim 3, wherein said cineole-based oil is essential oil of eucalyptus.

5. The animal repellant composition of claim 4, wherein said essential oil of eucalyptus is from the group consisting of Eucalyptus cneorifolia, Eucalyptus dives, Eucalyptus dumosa, Eucalyptus globulus, Eucalyptus goniocalyx, Eucalyptus horistes, Eucalyptus kochii, Eucalyptus leucoxylon, Eucalyptus oleosa, Eucalyptus polybractea, Eucalyptus radiate, Eucalyptus sideroxylon, Eucalyptus smithii, Eucalyptus tereticornis, Eucalyptus viridis, and mixtures thereof.

6. The animal repellant composition of claim 2, further comprising:
a solid portion; and
wherein said olfactory repellant, said cytokine inhibitor, and said carrier is absorbed by said solid portion.

7. The animal repellant composition of claim 6, wherein said solid portion comprises zeolite.
